(19) United States
(12) Patent Application Publication
(10) Pub. No.: US 2004/0267610 A1
(43) Pub. Date: Dec. 30, 2004

(54) Partner director gateway

(75) Inventors: James Alan Gossett, Solana Beach, CA (US); Daryll Michael Bennett, Vista, CA (US)

Correspondence Address: Joel D. Voelzke, Esq., FULWIDER PATTON LEE & UTECHT, LLP, Howard Hughes Center, 6060 Center Drive, Tenth Floor, Los Angeles, CA, 90045, US

(73) Assignee: Altient Corp.(a Delaware Corporation)

(21) Appl. No.: 10/609,936

(22) Filed: Jun. 30, 2003

(51) Int. Cl. G06F 17/60

(52) U.S. Cl. 705/14

(57) ABSTRACT

A hardware device or software plug-in or routine which shall be called a partner director gateway (PDG) receives a message which represents a request by an Internet user for a web page. The PDG checks to see whether the requested page belongs to an on-line vendor or other entity with which the PDG has an affiliate relationship, and if so modifies the message so that the user is first sent instead to an affiliate page at the vendor's site or an affiliate redirect page which is associated with the PDG operator. In this way the PDG operator such as an ISP receives pay-for-performance credit for activity performed by the user at the vendor's web site, and is thus provided with a monetary incentive to build networks and provide Internet access.

### RELATED APPLICATIONS

None.

### FIELD OF THE INVENTION

The present invention relates to the field of directing computer messages and providing Internet services, and more particularly to the field of directing Internet traffic so as to produce referral revenue for an ISP or other service provider.

### BACKGROUND OF THE INVENTION

An early business model which was used by web site publishers in order to help generate revenue and therefore pay for the time and cost of creating and maintaining web sites was to sell advertising space on their websites. In this model the publisher included banner ads or pop-up ads on the publisher's web site which linked to the advertiser's web sites, and in return the advertiser paid the publisher for the number of times a visitor to the publisher's web site was exposed to the advertisement. This model has been referred to as pay-per-impression. This was not a very successful business model, as many advertisers concluded that paying for exposure did not generate sufficient revenue and/or was not sufficiently targeted to justify payments made to the publisher. As a result, Internet advertising revenues fell significantly.

It has become more popular for advertisers to pay for results rather than mere exposure, as many advertisers believe that paying for results is a more effective use of their advertising dollars. In this model, an advertiser pays revenue to a web site publisher only when the user who is visiting the publisher's site takes a specific action relative to the advertisement or to the advertiser's site. The specific action can be clicking through from the banner or pop-up advertisement to the advertiser's web site in order to view the information at the web site or otherwise visit the site, actually making a purchase at the advertiser's web site, or filling out an informational survey. As used herein, pay-for-performance refers to any type of revenue sharing program where a publisher receives a commission for generating online activity which provides some benefit to an advertiser. Pay-for-performance is therefore an umbrella term which encompasses at least pay-per-referral, pay-per-purchase, and pay-for-collected-data. The relationship between advertiser and publisher is sometimes referred to as an affiliate relationship or partner relationship.

As used herein, the word “person” will be used in its legal sense to refer to an individual, a corporation, a partnership, an unincorporated association, or any other legally recognized entity; the word “publisher” will refer to any person who is responsible for creating and/or maintaining a world wide web site on the Internet, or more generally any accessible location on a computer network; and the word “advertiser” will refer to any person who creates and/or maintains a world wide web site on the Internet or other location on a computer network, and who derives some tangible or intangible benefit from having persons engage in certain activity such as visiting the advertiser's web site and viewing the information there, ordering goods or services from the advertiser, or filling out a survey at the advertiser's web site or otherwise providing information. Advertisers are most commonly online vendors of goods and/or services but are not limited to vendors. Online vendors are sometimes referred to as on-line retailers, e-tailers, or merchants.

In a typical pay-for-performance system, the web site publisher places one or more advertisements on the publisher's web site. The advertisements can be banner ads, pop-up ads, pop-under ads, or other types of ads. When a user clicks on the advertising banner or other advertisement via a mouse click or other selection mechanism, the web site browser running on the user's computer sends out to the Internet a message requesting the web page located at the Uniform Resource Locator (URL) corresponding to the hyperlink reference (HREF) command associated with the banner advertisement. The URL pointed to by the HREF command or its equivalent will be referred to as the affiliate URL or partner URL, and the web page which resides at the requested URL will be referred to as the affiliate page or partner page. After the user clicks on the advertisement causing the browser to request the affiliate URL, the web page located at the requested URL is returned to the user. In other words, by clicking on the banner ad the user is sent to the affiliate page. Typically the affiliate page is a subpage at an advertiser's web site, and is established by the advertiser specifically for that particular publisher. The requested page has code that includes a method for identifying the user which is typically accomplished by placing a cookie on the user's computer hard drive identifying at least the publisher. The page that the user sees at the affiliate page is essentially the advertiser's main page which is typically sent to the user through the affiliate URL The advertiser can thereafter read the cookie, thereby identifying the publisher as the referring site to receive pay-for-performance credit such as a percentage of any purchass made by the user at the advertiser's web site. Typically, the cookie expires after a certain amount of time. The foregoing is an example of what will be termed a two-party system, in which only an advertiser and a publisher participate without any middleman. FIG. 1 illustrates this prior art two-party configuration and will be described in greater detail below.

The advertisement displayed on the user's screen when he visits the publisher's web site may be a static advertisement, or it can be an image served up dynamically in real time by a third party advertising server. This configuration will be referred to as a three-party system. A three-party system includes an advertiser, a third-party advertising server, and a publisher all participating in the revenue chain. FIG. 6 illustrates this prior art three-party system and will be described in greater detail below. In the case of third party advertising servers the process is slightly different from that described above in a simple two-party advertiser-publisher relationship. The Commission Junction service, located at http://www.cj.com, is an example of a third party advertising server that dynamically serves up advertisements to web site publishers. In one model, in the advertisement served up by the third party advertising server, the HREF command may send the user first to the advertising server's web site, which then forwards the user to the advertiser's web site via a refresh command. A cookie placed onto the user's computer identifies the third party advertising server as the referring site to receive pay-for-performance credit, which the third party advertising server typically shares with the publisher. Thus, both the publisher and the third party advertising server share in the pay-for-performance revenue received from the advertiser.

Advertising revenue is also used to supplement the incomes of ISP's. A few ISP's even offer at least a limited number of free Internet connection hours per month, apparently deriving revenue from the advertising which appears on the home page of the ISP when a user first logs in, as well as banner or pop-up ads which appear when a user visits an unrelated web page using the ISP's service. It is presumed that ISP's derive revenue from affiliate relationships with advertisers, i.e., pay-for-performance revenue, and/or pay-per-impression revenue.

### SUMMARY OF THE INVENTION

A novel method and apparatus are disclosed herein which allows an ISP to provide Internet access while deriving revenue from affiliate relationships, thus making it economically more attractive to provide ISP service, including possibly free or reduced cost Internet access to a variety of persons at a variety of geographic locations. The invention will make it more economically attractive to build out networks and provide Internet access in a variety of settings and at a variety of locations including: public/municipal broadband cooperatives; airport passenger waiting areas; bus terminals; professional offices such as doctor and dentist waiting rooms; automobile repair shops; food and drink service locations such as coffee shops, cafes, and restaurants; places of public accommodation such as resorts, hotels, and motels; multiple tenant units such as in business complexes, apartments, motor home parks and recreational vehicle parks; or any other facility or location in which public or private Internet services are desirable. Access can be provided to various types of individuals such as residential customers or members of a doctor's office staff. The invention could give incentive for ISP's to provide more widespread and possibly even universal service to historically underserved persons and communities, thus helping to close the “digital divide” which is perceived by some people to be contributing to the gap between rich and poor.

The invention allows the ISP or other user of the invention to receive pay-per-performance credit from a variety of advertisers or partners for transactions conducted by users from the computers or terminals serviced, regardless of whether the user clicks on a banner ad, types in the advertiser's main URL into the browser URL bar, clicks on a link returned by a search engine, or clicks on some other type of text link to the advertiser's site.

According to one aspect of the invention, the ISP provides a Partner Director Gateway (PDG) which could be implemented in either hardware or software, and which is located between the user's browser and the Internet. In one embodiment, the ISP establishes affiliate relationships with a number of advertisers. When the user requests the main page of an affiliate by typing into the browser address bar at the user's computer the URL which the user wishes to visit, the PDG first determines whether the URL is a URL for one of its affiliates. If the URL is associated with an affiliate on the affiliate list, the PDG performs a URL swap by modifying the requested URL to point instead to the ISP's affiliate page in the case of a two-party system or affiliate redirect page in the case of a three-party system, thereby creating a modified URL request before sending the modified request over the Internet. In other words, instead of sending the user directly to the advertiser's main page as requested, the PDG swaps in a different URL into the outgoing message and thereby directly or indirectly sends the user to a page at the advertiser's web site at which the ISP will receive pay-for-performance credit for activity conducted by the user at the advertiser's web site such as making purchases.

The user could request a URL either by typing in the requested URL in the browser address or URL bar, by performing a search at a search engine and clicking on one of the resulting search hits, by clicking on an advertising image such as a banner ad, or by selecting a textual link or other link appearing on the user's computer screen. Regardless of how the user selects the URL, the PDG can perform the URL swap to send the user to the desired affiliate redirect page. In a preferred embodiment, the PDG implements rules to ensure that it is not diverting traffic from an unrelated person's affiliate page. In this way the PDG avoids wrongfully depriving another person of referral revenue.

In other aspects, the swapping of URLs could be implemented by persons or devices other than ISPs, including collocation facility providers, backbone node providers, and website hosts. The swapping of URL's could also be performed within a browser, or outside of the browser yet still within the user's computer either by hardware or by software. PDG software modules could be embedded into any networking device which routes Internet traffic such as routers, switches, wireless access points, embedded server appliances, residential gateways, kiosks or Internet Stations. The PDG software modules can also be embedded into software applications. These applications could be installed within any device that can interface with the Internet such as computers (including servers and workstations), mail stations, web TV, or mobile devices including cellular telephones, personal digital assistants (PDA's), web tablets, and personal communicators.

In a still further aspect, an ISP or other person need not necessarily modify the URL in order to receive credit from the advertiser, but could otherwise modify the computer message sent to the advertiser in order to pass the necessary information to the advertiser in order for the advertiser to give credit to the ISP. Such modification could include adding information to the text of the message identifying the ISP to the advertiser as the referral source.

In yet another aspect, the invention is of an apparatus for providing connections to the Internet and redirecting web page requests comprising: a first port for receiving a message from a computer user, said message including a received URL and a request for a web page associated with said received URL; a URL match section for detecting when said received URL meets a pre-defined criterion; a URL swapping section for swapping a second URL in place of said received URL if said URL match section detects that said pre-defined criterion has been met, said second URL defining a substituted URL, such that said message is modified to request a web page from said substituted URL instead of said requested URL; and a second port for outputting said modified message for routing to the Internet. The modified URLs can point to affiliate pages or affiliate redirect pages, and the device can be reprogrammed over the Internet or other computer network on which the device resides in order to easily and efficiently update the affiliate URL's to which the user will be sent and under what circumstances.

In other embodiments, the invention could be implemented in a proxy server. In yet a further aspect, the invention is of a computer readable medium capable of causing a computer or other programmable hardware device to implement any of the methods of the present invention.

Exemplary embodiments of the invention will be further described below with reference to the drawings, in which like numbers refer to like parts.

### BRIEF DESCRIPTION OF THE DRAWINGS

FIG. 1 is a diagram illustrating how a prior art Internet publisher/advertiser routing method operates in a two-party system.

FIG. 2A is a hardware diagram illustrating a first embodiment of the present invention in which a Partner Director Gateway is implemented at an ISP's facility.

FIG. 2B is a conceptual diagram illustrating how one embodiment of the Partner Director Gateway of the present invention operates.

FIG. 2C is a flow diagram illustrating the URL matching and modifying functions of one embodiment of the present invention.

FIG. 3 is a diagram illustrating how a prior art Internet publisher/advertiser routing method operates in a three-party system which includes a third-party advertising server.

FIG. 4 is a diagram illustrating a further embodiment of the present invention in which the Partner Director Gateway is implemented in a three-party system.

FIG. 5 illustrates another embodiment of the present invention in which the Partner Director Gateway function is implemented in software within a user's browser.

FIG. 6 illustrates a further embodiment of the present invention in which the ISP provides links directly to an advertiser's site independent of the user's Internet window.

FIG. 7 illustrates a still further embodiment in which the invention is implemented in a proxy server.

FIG. 8 is a conceptual diagram illustrating how the invention operates to produce revenue to an ISP.

### DETAILED DESCRIPTION OF EXEMPLARY EMBODIMENTS

In the discussion which follows, the term “referral revenue” or “referral credit” will refer to any type of monetary or non-monetary consideration or credit given for any computer activity. The term “referral revenue” or credit includes traditional pay-for-performance revenue including pay-per-referral, pay-per-purchase, and pay-for-collected-data. The term “referral revenue” also includes payments for any other type of on-line activity. A non-limiting list of such payments includes payments depending on the amount of time that the web site visitor spends at the advertiser's website, the number of different pages the visitor views, the extent and/or quality of activity such as winning a game at the advertiser's site, and whether the user clicks through from the advertiser's site to another advertiser's site.

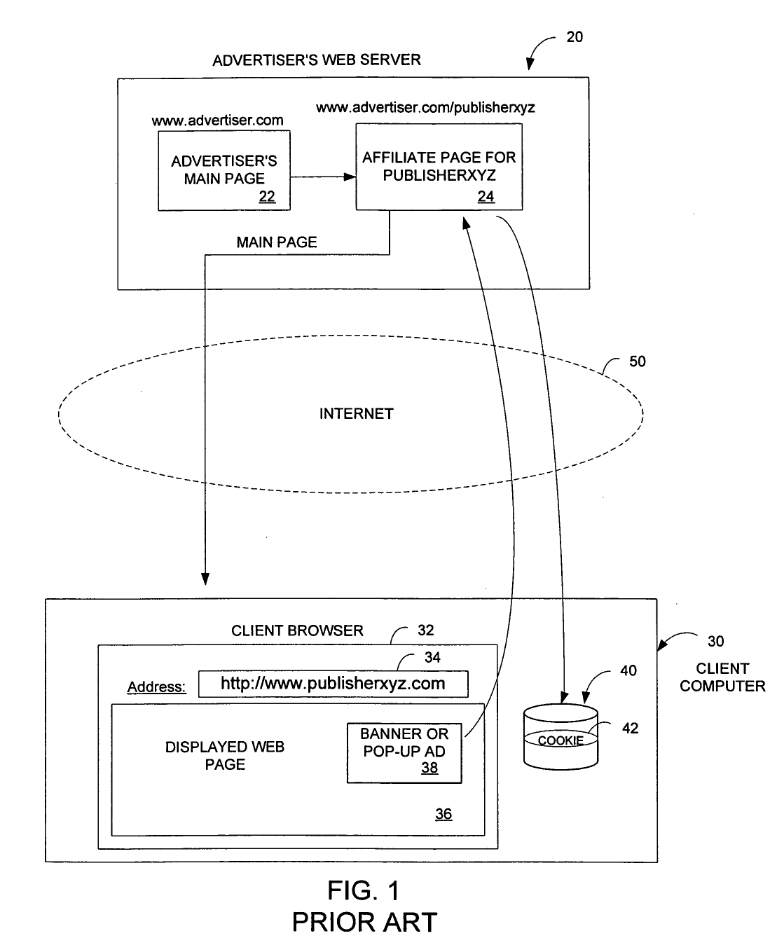

FIG. 1 illustrates a prior art advertiser/publisher affiliate relationship in a two-party system. An exemplary and well known advertiser is Buy.com, Inc., which operates the site located on the world wide web at http://www.buy.com. This familiar advertiser and its web site will be used for illustration purposes only within the following discussion; no relationship between Buy.com, Inc. and the assignee of the present invention is to be inferred therefrom. Additionally, except as specifically noted the user should not infer that the site buy.com actually operates exactly in the manner described below, as the following discussion is for illustration purposes only. In the following discussion, URL's will sometimes be referred to without the leading “http://www” or “http://” for convenience and brevity, and it will be understood from the context that the complete URL would include the omitted characters.

The advertiser's web site residing on the advertiser's web server 20 includes a main page 22 such as buy.com, and a number of affiliate pages 24 located on various subpages underneath the main page 22. Each affiliate page is established for the benefit of a particular publisher. For illustration purposes, a first publisher might be PublisherXYZ.com, Inc., which operates a web site located at www.publisherxyz.com. When a computer user operating a user computer 30 uses the Internet to visit the website www.publisherxyz.com such as by typing http://www.publisherxyz.com into his browser URL window, the browser receives the requested page from across the Internet 50. The user can view the content published at that page. The user is also exposed to banner ads or pop-up ads 38 which appear on displayed web page 36. If the user clicks on advertisement 38, the user's browser 32 sends a request out onto Internet 50 for the web page located at the URL contained within the HREF command associated with the banner ad or pop-up ad image. For example, the publisherxyz.com page could include the following HTML code:

<A: HREF=“http://www.buy.com/publisherxyz>

<IMG SRC=“http://www.buy.com/images/publisherxyz.img></A>

The foregoing is a simple example in which a static banner ad image is retrieved from buy.com in real time and displayed on publisherxyz.com. More complex arrangements are possible in which the ads change every time the user visits publisherxyz.com, or in which the ads cycle or rotate, or otherwise change over time or in response to other conditions or parameters. Those variations are well known and are within the ordinary skill of an Internet programmer to implement.

Regardless of the details of implementation, the result is that the user is sent to a requested page 24 associated with the advertisement and which is a page associated with the affiliate. The page received by user 30 is typically essentially the advertiser's main page 22 ported to the user through the affiliate page 24. One small difference is that through the affiliate page the advertiser places a cookie 42 onto the user's hard drive 40 which identifies the user as having been referred to the advertiser by PublisherXYZ. Cookies are small computer files which can be placed onto a client computer's hard drive by the world wide web page being visited, and which the website which placed that cookie there can thereafter read when that user visits the site again. Although the user typically sees a page which is essentially the advertiser's main page, in theory an advertiser could set up much different pages for each different affiliate page 24. Because the user's hard drive 40 now contains cookie 42 which identifies PublisherXYZ as the referring site, every time the user makes a purchase at the advertiser's web site or performs some other action which triggers pay-for-performance credit by buy.com to its referring sites, PublisherXYZ will receive that pay-for-performance credit.

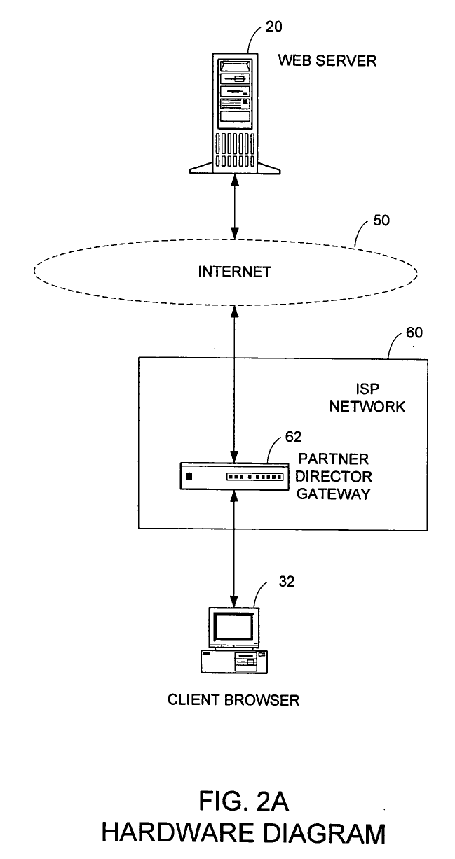

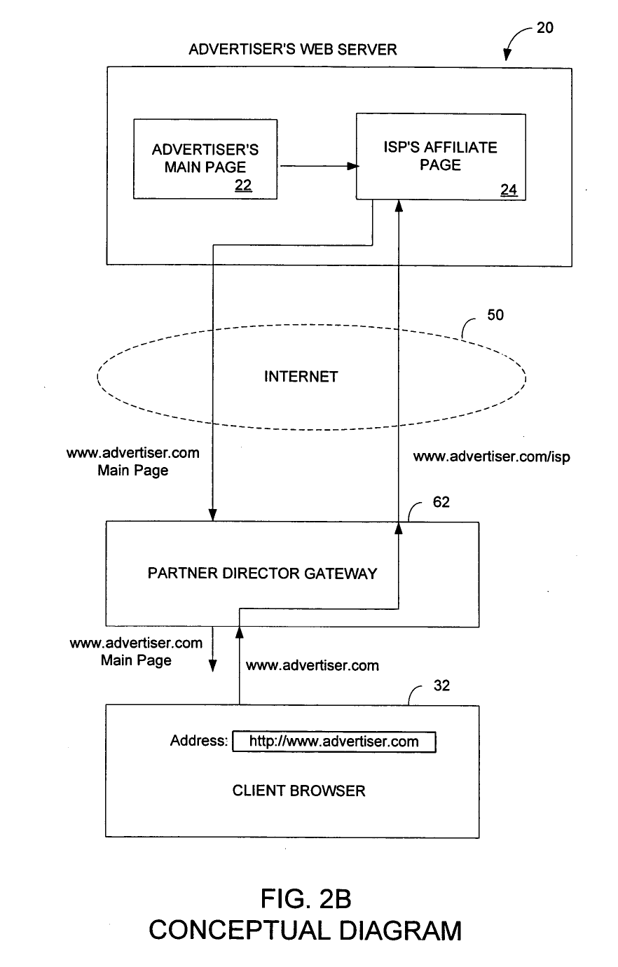

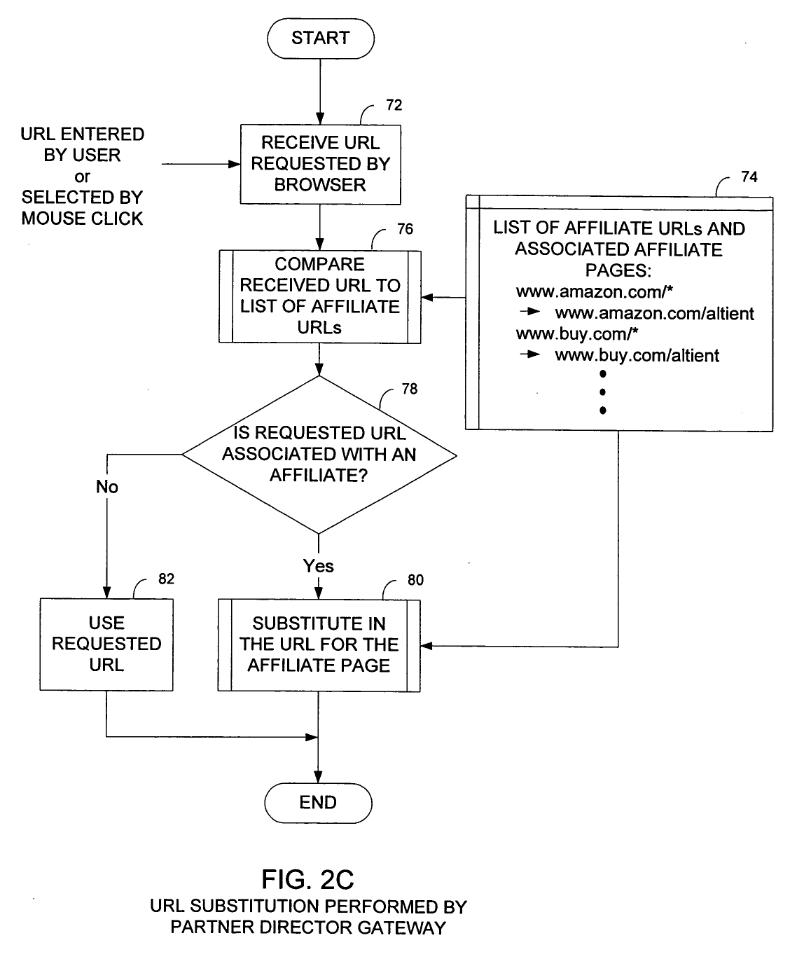

FIG. 2 illustrates a first embodiment of the Partner Director Gateway (PDG) 62 of the present invention as applied to a two-party system. In this embodiment, PDG 62 may be a hardware or software plug-in which resides between the user's browser 32 and the ISP's connection to Internet 50. PDG 62 may be installed and/or controlled by the ISP.

FIG. 2A is a hardware diagram illustrating this embodiment. Network access details are omitted for clarity of illustration. The ISP provides Internet connection services to the user's client browser 32 residing on the user's computer. When the user requests a particular web page, such as by typing in a URL into the browser address bar or clicking on a link, the browser sends out a message requesting the web page residing at the requested URL. The message request includes the requested URL for the advertiser's main page, which will be referred to herein generically as www.advertiser.com or in the illustrative example www.buy.com. PDG 62 residing somewhere within the ISP Network 60 intercepts the message, and checks the message to determine if the requested URL is associated with one of the ISP's partners. If so, the ISP modifies the message by performing a URL swap, i.e., by replacing the requested URL with the URL for the affiliate web page associated with the ISP. The message which PDG 62 passes along for eventual placement on the Internet no longer includes the requested URL www.advertiser.com, but now includes in its place the affiliate URL www.advertiser.com/isp where www.advertiser.com/isp is the URL of the ISP's affiliate page at the advertiser's web site. PDG 62 includes predefined criteria for identifying web pages associated with particular advertisers, and associated affiliate pages or affiliate redirect pages to which to send the users. For example, PDG 62 can detect when a user is requesting a page located at www.buy.com/* where * is some criteria, and redirect the user to the affiliate page www.buy.com/altient. Similarly, PDG 62 can detect when a user is requesting a page located at www.amazon.com/* and redirect the user to www.amazon.com/exec/obidos/redirect-home/altient-20 which is the current affiliate redirect page on the Amazon.com website established for the assignee of the present invention.

FIG. 2B is a conceptual diagram graphically illustrating the redirecting features of this embodiment. Using client browser 32 the user requests the advertiser's main page 22 located at www.advertiser.com. The user may request the main page 24 either by typing in its URL into the browser address bar, by picking the page from a list of “favorites,” by clicking on a banner ad, by clicking on a text link such as a link obtained from a search engine, or by any other method. Instead of receiving the requested page directly, the user is sent by PDG 62 to the affiliate page 24 through which the user will receive both a cookie identifying the ISP as the referring site as well as the requested page ported through the affiliate page, or a similar page residing at that affiliate page. The result is that the ISP will appear to the advertiser as simply another publisher, and the ISP will receive any pay-for-performance revenue generated by the user's activity at the advertiser's site such as making a purchase.

As described above, it is possible that PDG 62 will divert Internet traffic that would otherwise have resulted in credit being given to a second and unrelated publisher. For example, if a user visits the website www.PublisherABC.com and clicks on a banner ad that would normally send the user to www.buy.com/publisherabc.com, the PDG might send the user to www.buy.com/publisherxyz.com, thus diverting referral credit from PublisherABC to PublisherXYZ. In order to avoid this problem, the PDG 62 can implement more refined rules for deciding when to perform a URL substitution. For example:

http://amazon.com

http://www.amazon.com

http://www.amazon.com/exec/obidos/subst/home/home.html

all end up at the same place. Other sites may have default pages as their main pages, such as .../default.asp, .../index.asp, .../index/cfm, ..../index.htm, .../index.html, or .../index.shtml. By creating a Regular Expression similar to: “regexi (www.)?amazon.com/(default.asp|default.html|default.html|home.html|home.html|index.asplindex.cfm|index.html|index.html|index.shtml|$) http://www.amazon.com/exec/obidos/redirect-home/altient-20” PDG 62 will redirect the user to Altient's affiliate redirect page on the Amazon.com server only when the requested page is Amazon.com's default page or its equivalent, and not when the requested page is an affiliate page associated with an unrelated publisher. Various rules could be written to accommodate combinations of possible URL's. In this way, Internet traffic that results from somebody else's Internet publishing is passed through unchanged, but Internet traffic that is generated solely by the ISP or otherwise not credited to another person may be diverted so as to result in traffic generation revenue for the ISP or other operator of PDG 62.

FIG. 2C is a flow diagram of the URL substitution process. At step 72 the PDG receives a requested URL from a computer user. At steps 76 and 78 the PDG compares the received URL to its predefined list of domains and set of rules 74 or list for determining whether a URL of an affiliate redirect page should be substituted in place of the requested URL. In the figure, an asterisk (*) generally denotes a predefined rule or set of rules rather than simply a wild card. If the requested URL matches the list or predefined rules, at step 80 the URL of the corresponding affiliate redirect page is substituted in for the requested URL; otherwise, at step 82 the requested URL is used without change. The affiliate page URL's given in block 74 are truncated for illustration purposes. Thus, it will be understood for example that the affiliate redirect page URL of www.amazon.com/altient is a shorthand way of designating the full redirect page, which is www.amazon.com/exec/obidos/redirect-home/altient-20 as currently implemented.

As used herein, it will be appreciated that the terms URL “swap” or “substitution” should be interpreted broadly to include any modification to the URL. The URL swap or substitution need not mean that the new URL to be used is entirely retrieved from memory. Instead, the new URL could be built up in real time from the received URL, such as by a truncation and concatenation operations. For example, if the requested URL is www.amazon.com/index.html, and the affiliate page to which the user will be sent is www.amazon.com/exec/obidos/redirect-home/altient-20, the new URL could be constructed by truncating off the “index.html” part and concatenating the “exec/obidos/redirect-home/altient-20” part to the truncated URL to obtain the URL of the affiliate page. Accordingly, the term “swapping” or “substituting” a different URL for the received or requested URL will be understood to encompass both literal substitution of the entire URL as well as changing the requested URL by performing various operations on it.

The user can be redirected to pages other than pages that are equivalent to the advertiser's main page. The advertiser could set up a number of affiliate pages for each of its publishers. For example, if an advertisement were placed on a website for digital cameras because the publisher web site would be expected to draw visitors who might be particularly interested in digital cameras, clicking on the link could bring a user to an affiliate page at buy.com that was set up for PublisherXYZ and which presented to the user a page on the buy.com website at which digital cameras were offered for sale. Similarly, different pages could be set up for different products offered by the advertisers.

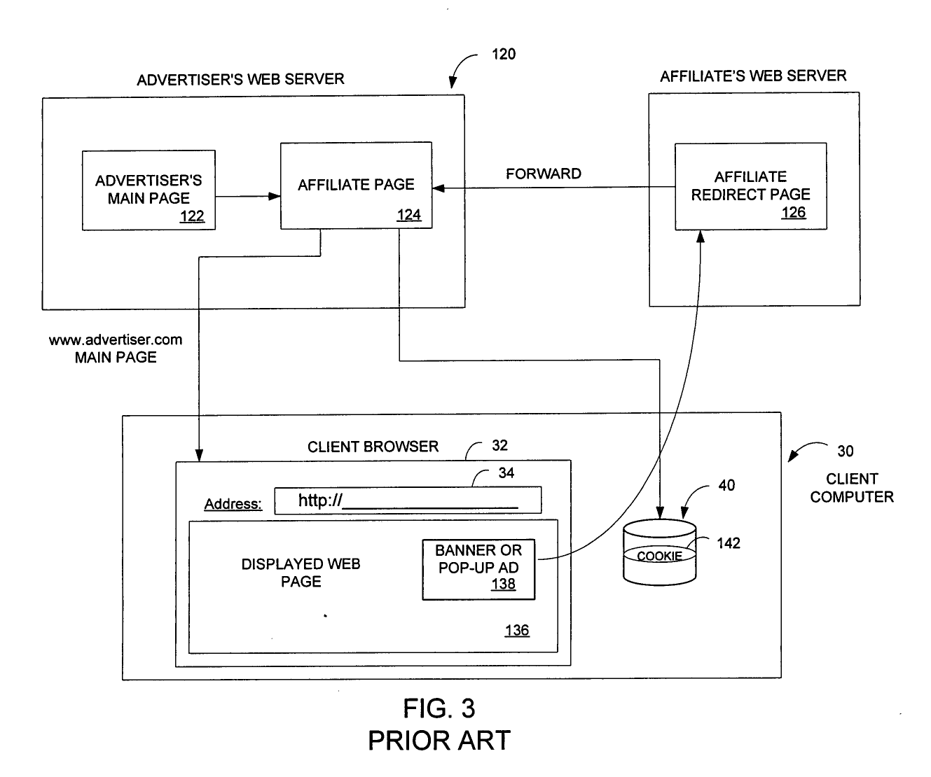

The foregoing illustrates the use of the invention in a two-party system. FIG. 3 illustrates an exemplary prior art three-party system in which the invention can also be employed. In the figure, the Internet has been omitted for clarify of illustration. A three-party system typically includes an advertiser, a publisher, and a third-party advertising server. An illustrative third party advertising server is Commission Junction, Inc. The third party advertising server serves up banner or pop-up advertisements 138 which are called from a publisher's web page 136 by the HTML code or equivalent within the publisher's web page 136. Those advertisements therefore appear within publisher's web page 136 as seen by a visitor to the publisher's web site. When the user clicks on banner advertisement 138, the user is sent to a page residing on the advertising server's web site called an affiliate redirect page 126. That is, the user clicks through from the publisher's web site to affiliate redirect page 126. That affiliate redirect page is a unique page which has been established by the third party advertising server for the benefit and traffic of that particular publisher. The advertising server logs the user as having come to affiliate redirect page 126 by having clicked through from the particular publisher's website. Affiliate redirect page 126 includes code that redirects or forwards the user to the affiliate page 124 residing on the advertiser's web server 120. The forwarding may be accomplished by a REFRESH command such as:

<meta http-Equiv=“refresh” content=“0”

url=http://www.advertiser.com/affiliatepage>

or its equivalent in Java Script or other programming code. This code causes the client's browser to “refresh” its page by retrieving the page residing at http://www.advertiser.com/affiliatepage and using that page as the new page. Because the URL in the REFRESH command is actually a different page, the result is that the browser is forwarded to a new page. The forwarding happens so quickly that the user usually does not notice any appreciable delay. Affiliate page 124 places a cookie 142 on the user's hard drive 40 identifying the user as having been referred to the advertiser's web site by the advertising server, and ports the advertiser's main page to the user through the affiliate page, similar to what the advertiser does in the two-party system. When the user makes a purchase at the advertiser's web site or otherwise triggers pay-for-performance credit, the third party advertising server such as Commission Junction, Inc. receives that referral revenue. The third party advertising server then splits its commission with the publisher from which the user clicked through.

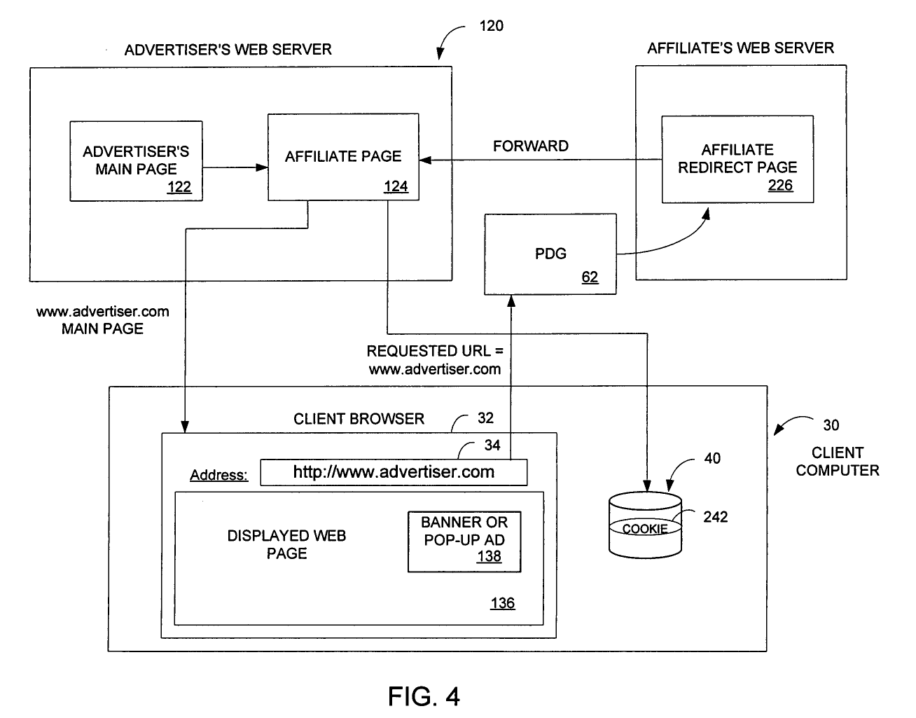

FIG. 4 illustrates an embodiment in which the Partner Director Gateway 62 of the present invention is implemented in the illustrative three-party system of FIG. 3. PDG 62 resides somewhere between the client browser 32 and the Internet, which may include implementation at an ISP's facility. The ISP or other operator of PDG 62 establishes a relationship and an account with the third party advertising server, similarly to the relationship and account which might be established by any publisher. When the user types in a URL into the URL bar or address bar 34, selects a “favorite,” clicks on a link, or otherwise requests a web page such as www.advertiser.com from the advertiser's web site, PDG 62 intercepts that URL request and checks to see whether the advertiser is on its list of affiliated web sites. If so, then PDG 62 performs a URL swap, and sends the user instead to the affiliate redirect page 226 residing on the third party advertising server's web site which has been established for the benefit and traffic of the PDG operator. Now the third party advertising server such as Commission Junction logs the PDG operator as the referring site, and forwards the user to the affiliate page 124 on the advertiser's web site. The result is that the PDG operator or his designee is given credit for any pay-for-performance revenue generated by that user at the advertiser's web site.

At this point it may be observed that, without other modification, implementing the foregoing may create an infinite loop problem, wherein for example the user requests the page buy.com, PDG 62 redirects him to buy.com/isp which then forwards him to buy.com, PDG 62 redirects him again back to buy.com/isp, and ad infinitum. There are several possible solutions to this problem, some of which depend on how the advertiser's site is constructed.

A first situation is when the main page of the advertiser has the same URL as a user might type into the address bar, such as buy.com. In order to avoid the infinite loop problem, the affiliate redirect page forwards the user to some page on the buy.com website other than the main buy.com page. For example, the affiliate redirect page could send the user to http://www.buy.com/retail/savings central.asp?loc=15384&dcaid=1688, on which buy.com lists its “Super Savings.” In this situation, therefore, the affiliate redirect page forwards the user to a page which does not satisfy the predefined rules for performing the URL swap, and no infinite loop is created.

A second situation is illustrated by the current construction of the amazon.com web site. When a user requests amazon.com, the main Amazon.com, Inc. web page that is actually returned to the user and which then appears in the user's browser address bar may be something like http://www.amazon.com/exec/obidos/subst/home/home.html/102-8109139-8176113. With the PDG in place and operating, when the user types in www.amazon.com into the browser address bar, the PDG sends the user to the affiliate redirect page which in the case of the assignee of the present invention is http://www.amazon.com/exec/obidos/redirect-home/altient-20. That affiliate redirect page then forwards the user to the main page located at http://www.amazon.com/exec/obidos/subst/home/home.html/102-8109139-8176113. Because the URL http://www.amazon.com/exec/obidos/subst/home/home.html/102-8109139-8176113 does not match the Regular Expression or other predefined criteria which triggers the URL substitution, the user remains at http://www.amazon.com/exec/obidos/subst/home/home.html/102-8109139-8176113 and there is no infinite loop problem. With the website amazon.com as currently constructed, therefore, there is no infinite loop problem.

Other ways to prevent or break the infinite loop are possible. In one method, the PDG maintains a record of which users it forwarded to which affiliate redirect pages, and if the user has been redirected to that affiliate redirect page more recently than a predefined time, say 30 seconds or the cookie expiration period, then the PDG will not redirect the user again to the same affiliate redirect page. The user could be identified by various means including possibly the user's Internet Protocol (IP) address.

Another possible although potentially difficult way to break the infinite loop would be to read the advertiser's cookie. As long as the cookie has not timed out and remains on the user's hard drive, the PDG will not perform the URL swap to redirect the user to the affiliate redirect page.

These techniques for breaking the infinite loop take advantage of the fact that it is not necessary to perform a URL swap if the user already has a cookie which identifies the user as having been sent by the ISP. As long as the cookie remains on the user's hard drive, the advertiser will read the cookie and know that the user was forwarded to the site by the ISP or other operator of the PDG, and will give that person credit for directing that Internet traffic to the advertiser's web site.

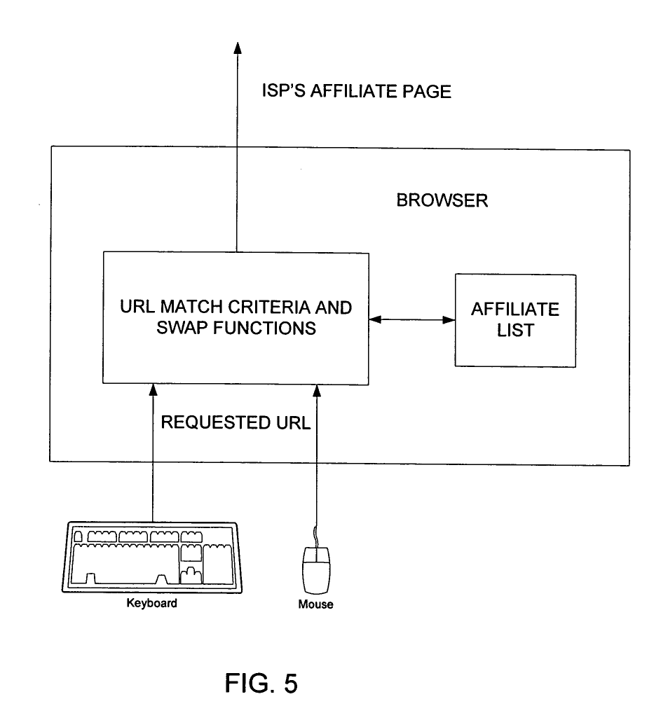

FIG. 5 illustrates a further embodiment in which the PDG is implemented in software within the user's browser. In this embodiment, the user requests a URL by either entering that URL at the user's keyboard or selecting a link via the user's mouse, and the browser itself checks the requested URL to determine whether the web site is an affiliate, and if so performs the URL swapping to send the user instead to the associated affiliate page or affiliate redirect page. This embodiment has the disadvantage that the browser software would need to be updated in order to ensure that the user was not being sent to an outdated or no longer existing affiliate redirect page. Various ways to automatically update software or to encourage the user to download the latest version of a software program are well known within the programming and marketing arts. In another embodiment, the PDG could be implemented in the form of a software plug-in which is loaded onto the browser's computer. The plug-in would intercept the Internet message after it left the user's browser but before it is placed on the user's computer telephone jack, Ethernet connector, or other hardware port by which the user connects to the Internet.

In another embodiment, the operator of the PDG is a hotspot provider. Hotspots are areas in which a wireless Internet connection or other wireless network connections are provided. When a user whose computer is equipped with a wireless Internet connection is within a hotspot service area, the user can connect to the Internet using the wireless network connection provided by the hotspot provider. In the hotspot embodiment, the PDG is placed somewhere between the hotspot transceiver and the Internet node, and modifies requests for advertisers' main pages to be requests for the associated affiliate pages or affiliate redirect pages. The hotspot operator will therefore be able to collect revenue whenever a hotspot user types in the URL of one of the hotspot's partners and makes a purchase from the site, or otherwise triggers a pay-for-performance credit. In this way, a hotspot operator is given incentive to create wide hotspot coverage areas, which results in significant public benefits.

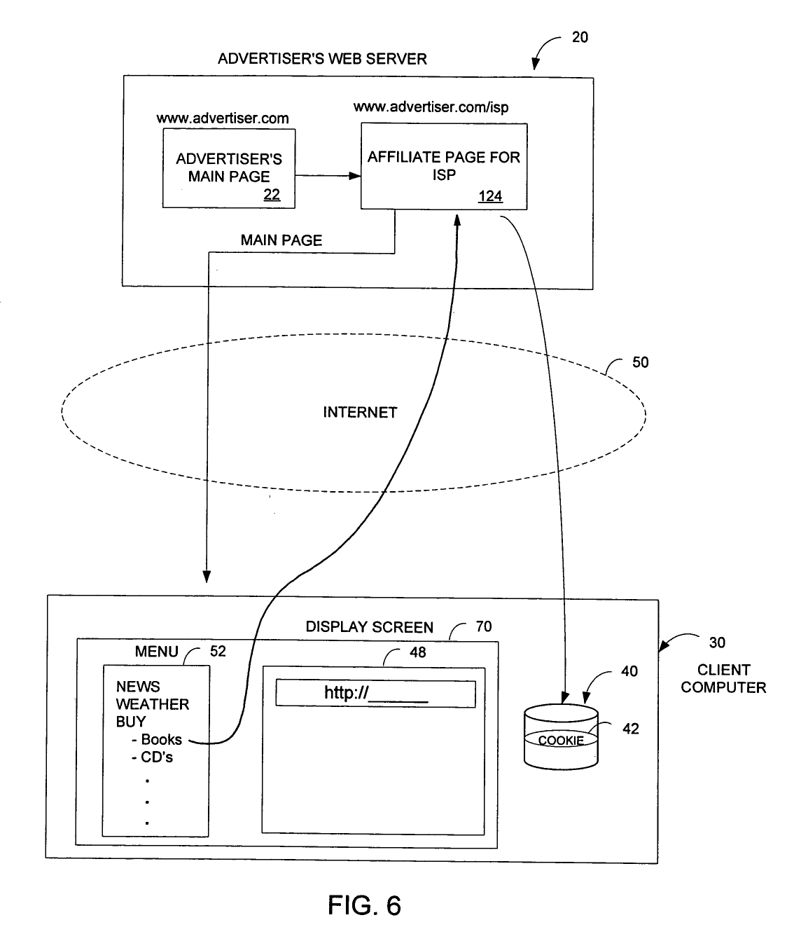

FIG. 6 illustrates a further embodiment in which the page served up to the user by the ISP includes both a window 48 for a conventional browser as well as a separate menu window 52 which contains a menu of links. This separate menu of links could allow the user to access a number of services including services that are provided directly to the user by the ISP or are repackaged by the ISP such as news, weather, and sports scores. The menu could include a “buy” option, such that when the user clicks on that option the user is presented with a more detailed menu giving the user the option to shop for books, CD's, cameras, etc. When the user finally selects one of the links such as “books” within the menu, the user would be sent to a bookseller such as Amazon.com through the affiliate redirect page, resulting in the ISP receiving credit for the referral and resulting sale. The Amazon.com website page could appear either within the separate browser window 48 or that page could take up the entire user's page from the ISP. Similarly, some or all of the links within the separate menu window 52 could send the user to various affiliate redirect pages which then forward the user to a page containing the desired content.

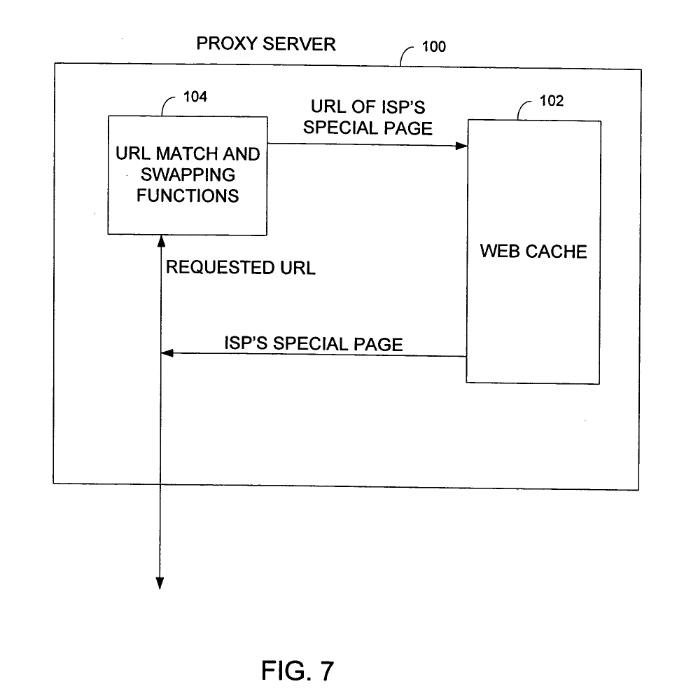

FIG. 7 illustrates another embodiment in which the invention is implemented in a proxy server. Proxy servers are cache memories that cache the most commonly requested web sites or web pages, and return them to the user without actually going out across the Internet and retrieving the requested web site from the web site server. Proxy servers therefore allow users to see pages more quickly and with a significantly less network burden than if the web site server were accessed every time a user requested a page. A proxy server 100 includes a standard web cache 102 for caching web pages and returning them as requested. However, proxy server 100 also includes URL match and swapping functions 104 for modifying the URL when the requested URL is on the affiliate list, i.e., is an advertiser willing to give referral credit such as pay-for-performance credit to third persons for referring or directing traffic to the advertiser's website. The user requests a web page such as by typing in advertiser.com or clicking on a link to advertiser.com, thereby causing the requested URL to be sent to the proxy server. In the URL matching and swapping function 104 the proxy server 100 determines whether advertiser.com is on its list of affiliates by comparing the requested URL to a set of predefined rules or to a list of affiliate URL's, and if so then instead of returning its cached version of the requested advertiser.com main page, returns the affiliate redirect page associated with the publisher, which may be a cached version held in cache 102 of the affiliate redirect page residing on the third party advertising server's web server. If and when the user makes a purchase at the advertiser's web site or otherwise triggers pay-for-performance credit from the advertiser, the person operating the proxy server 100 or his designee will receive the credit. Of course, as with the other implementations, it not necessary that the legal entity which operates the PDG be the same legal entity to whom the check will be sent by the advertiser.

In a still further embodiment the invention could be implemented by a search engine operator. In this embodiment, the search engine operator would perform its normal operations of crawling through the Internet in order to index pages as well as receiving and responding to requests to index particular pages. However, in response to a search request the search engine would return a modified hit list according to the general principles disclosed above. The unmodified hit list might include the unmodified URL of www.advertiser.com, but the modified hit list actually returned to the user would contain in place of the unmodified URL the URL of www.advertiser.com/altient, where www.advertiser.com/altient is the affiliate page at the advertiser's site for publisher Altient. The “/altient” portion could be included only in the HREF command and therefore hidden from the view of the computer user in order to avoid cluttering the user's screen. Similarly, in a three-party system the modified search engine hit list would include the modified URL pointing to the appropriate affiliate redirect page. Thus, a user who clicked through from the returned hit list to a particular vendor would be understood by that vendor to have been referred by an affiliate. The search engine operator would therefore receive pay-for-performance credit, whether the search engine operator received all of the credit as in a two-party system or split that credit with another party such as an advertising web server in a three-party system. The modification of the URL's could be performed either at the time of indexing or at the time that search results are returned to the user.

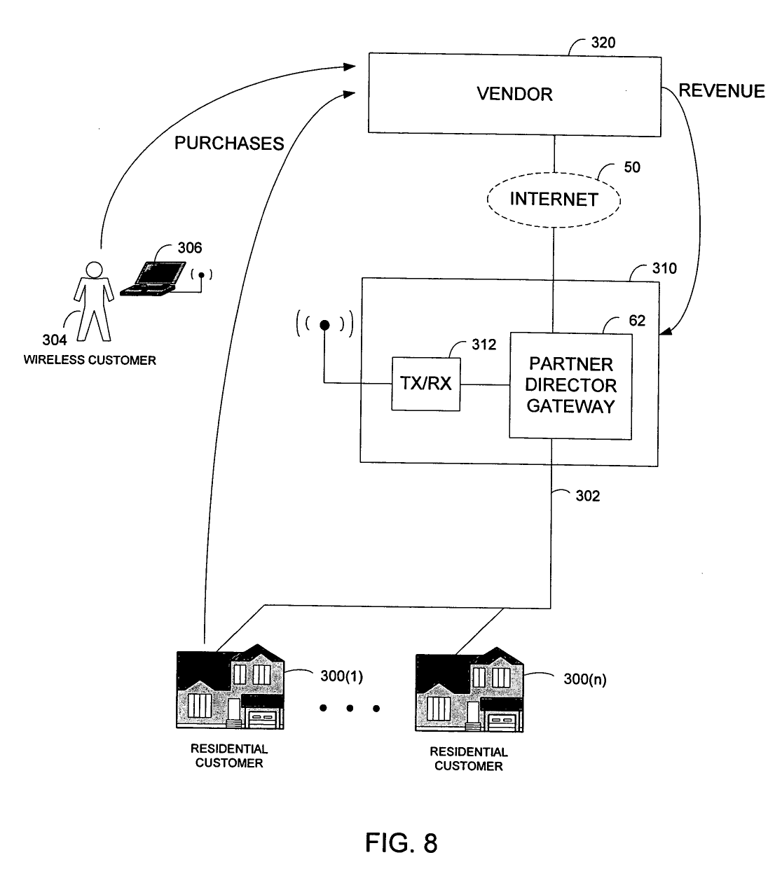

FIG. 8 is a conceptual diagram that illustrates one example of how the invention can provide revenue to an ISP, thus providing an incentive to provide Internet access to a number of different customers and using a number of different access types. In the illustration, ISP 310 provides wireless Internet access services such as hotspot service through a transceiver 312 to a wireless Internet customer 304 operating a laptop computer 306 equipped for wireless Internet access. ISP 310 also may provide Internet access through hard wires 302 such as telephone, cable modem, or LAN to a plurality of users or subscribers, shown as a plurality of residential homes 300(1) through 300(n). ISP 310 includes a PDG 62 which performs the checking of the requested URL's, and when appropriate the swapping of URL's. When the subscribers or users 304 and 300(1) through 300(n) request a page from the web site of vendor 320, PDG 62 performs the swapping of URL's if appropriate according to principles of the invention disclosed above. In this way, purchases by the users from vendor 320 produce a revenue stream for ISP 310. The more that users use the system to make purchases or otherwise engage in pay-for-performance producing activity, the more revenue ISP 310 will receive. Thus, ISP 310 is given incentive to provide wide coverage and fast, reliable service to its customer base.

In a still further embodiment, an operator of the PDG need not be a traditional ISP, but could be any entity that provides an Internet terminal or connection. For example, the PDG operator could provide Internet access terminals at public, semi-public, or private places, such as airport and bus terminals, doctors' and dentists' patient waiting areas, automobile car repair customer waiting areas, jury assembly rooms, restaurants, coffee shops, libraries, cafes, or any place where people would access the Internet if given the opportunity. In one embodiment, the PDG operator provides a Local Area Network (LAN) with computers in a doctors' patient waiting area, and also within the private areas of the doctors' offices accessible only to the doctor and/or the doctors' staff. Depending on the economics, kiosks or other terminals could be provided to the public free of charge or for a lower per-hour price than would otherwise be required.

The detailed design of the hardware or software for implementing the functions taught above are not crucial to the invention, and it is within the skill of ordinary practitioners of Internet hardware and software design to implement the PDG as taught herein.

It will be appreciated that the term “present invention” as used herein should not be construed to mean that only a single invention having a single essential element or group of elements is presented. Although the present invention has thus been described in detail with regard to the preferred embodiments and drawings thereof, it should be apparent to those skilled in the art that various adaptations and modifications of the present invention may be accomplished without departing from the spirit and the scope of the invention. Additionally, the present invention is not limited to use on the Internet and the world wide web, but could be adopted for use with other computer networks and protocols, including computer networks and protocols which have not yet been invented or implemented. As such, it will be understood that the foregoing disclosure is applicable for use with any computer addresses rather than merely URL's. Further, although the programming language Hyper Text Markup Language (HTML) has been used for illustration purposes, the invention is not limited to implementation using HTML, XML, Java Script, or any other particular language or protocol. It will also be appreciated that ISP's or other operators of the PDG as discussed herein could provide dial-up Internet service, broadband Internet service such as DSL or cable modem, or other types of service. It will also be understood that although an ISP as operator of the PDG has been used for illustration purposes, any person operating at any point within a computer network could implement a PDG and thus obtain pay-for-performance credit for itself or another person. Still further, it will be understood that the system need not be used to subsidize the cost of providing Internet service to subscribers, but rather could be used simply to create and/or enhance revenue for the entity practicing the invention. Accordingly, it is to be understood that the detailed description and the accompanying drawings as set forth hereinabove are not intended to limit the breadth of the present invention, which should be inferred only from the following claims and their appropriately construed legal equivalents.

What is claimed is:

1. A method of directing computer network traffic to affiliate web sites for the purpose of generating referral revenue for a third party, comprising:
establishing affiliate relationships with a plurality of affiliate web site operators, the affiliate web site operators being willing to give referral credit to a referral source;
receiving a requested URL from a user;
determining whether the requested URL is associated with one of said affiliate web site operators, and if so issuing a modified URL request, the modified URL request resulting in said affiliate web site operator giving referral credit to said third party.

2. The method of claim 1 wherein said modified URL points to a web page which identifies a web site visitor and causes the visitor to be automatically forwarded to a second web site page.

3. The method of claim 1 wherein said modified URL request is a request for an affiliate redirect page, said affiliate redirect page including computer instructions which forwards a user's browser to a second page which causes a cookie to be placed on computer of said user, the user being able to make can make purchases from said affiliate web site operator through said second web page.

4. The method of claim 1 wherein said referral revenue is selected from the group consisting of pay-per-referral, pay-per-purchase, and pay-for-collected-data.

5. The method of claim 1 wherein said requested URL is typed directly into an address bar by an Internet user, and said modified URL request requests an affiliate page located at the same domain as said requested URL.

6. The method of claim 1 wherein said requested URL is typed directly into an address bar by an Internet user, and said modified URL request requests an affiliate redirect page located at a different domain than said requested URL.

7. The method of claim 1 wherein:
said receiving a URL request comprises intercepting a message containing said requested URL before said message is passed to an Internet backbone node;
said issuing a modified URL request includes substituting a modified URL in place of said requested URL, passing said modified URL along for eventual routing to an Internet backbone node; and not passing said requested URL to an Internet backbone node;
such that an original URL request from a user is modified before being passed to an Internet backbone node, and the third party is given referral credit for directing user traffic to the modified URL.

8. The method of claim 1 wherein said step of issuing a modified URL request is performed only after checking said URL to ensure that said URL does not point to an affiliate redirect page associated with a different person.

9. The method of claim 7 wherein said steps of intercepting a message and issuing a modified URL request is performed by an Internet service provider.

10. The method of claim 7 wherein said steps of intercepting a message and issuing a modified URL request is performed by a collocation facility provider.

11. The method of claim 7 wherein said steps of intercepting a message and issuing a modified URL request is performed by a backbone connection provider.

12. The method of claim 7 wherein said steps of intercepting a message and issuing a modified URL request is performed by a provider of wireless Internet access services.

13. The method of claim 12 wherein said steps of intercepting a message and issuing a modified URL request is performed by a hotspot provider.

14. A computer readable medium containing computer code capable of causing a programmable electronic device to receive a message requesting a first web page, selectively modifying the message to request a second web page rather than the first web page for the purpose of generating pay-for-performance credit, and forwarding the resulting modified message for placement onto the Internet.

15. A method of modifying a request for an Internet web page comprising:
receiving a message, said received message including a request for a web page;
modifying said received message to include information which will cause pay-for-performance credit to be given by a first person to a second person, thereby defining a modified message; and
causing said modified message to be sent across the Internet.

16. The method of claim 15 wherein said received message includes a URL address, and said modifying said received message comprises leaving said URL unchanged but adding information within a body of said message.

17. The method of claim 15 wherein said received message includes a URL address, and said modifying said received message comprises replacing said first URL address with a second URL address.

18. The method of claim 15 wherein said second URL address is an address for an affiliate redirect page.

19. The method of claim 15 wherein said message modifying is performed by a software application running at an Internet user's terminal.

20. The method of claim 19 wherein said message modifying is performed by a browser.

21. The method of claim 15 wherein said message modifying is performed by an Internet Service Provider.

22. The method of claim 19 wherein said message modifying is performed by a web site host.

23. A method of providing access to the Internet in publicly accessible places comprising:
providing Internet service to a computer located in a publicly accessible location such that a person can access the Internet using said computer and a browser running on the computer; and
when said user requests a page from a web site associated with a first party, modifying the page request sent by the browser before the message is placed onto the Internet such that a second party is given credit for directing the user to the web site.

24. The method of claim 23 wherein said publicly accessible location is selected from the group consisting of a doctor's office, a dentist's office, and an auto repair business.

25. The method of claim 23 wherein said publicly accessible location is selected from the group consisting of an airport, a bus terminal, a restaurant, a café, and a coffee shop.

26. The method of claim 23 wherein said access to the Internet is provided to users without charge.

27. An apparatus for providing connections to the Internet and redirecting web page requests comprising:
a first port for receiving a message from a computer user, said message including a received URL and a request for a web page associated with said received URL;
a memory for holding a plurality of stored URL's;
a URL match section for detecting when said received URL meets a pre-defined criterion from among a set of pre-defined criteria;
a URL swapping section for swapping a selected one of said stored URL's in place of said received URL if said URL match section detects that said pre-defined criterion has been met, said selected one of said stored URL's defining a substituted URL, such that said message is modified to request a web page from said substituted URL instead of said requested URL; and
a second port for outputting said modified message for routing to the Internet.

28. An apparatus as defined in claim 27 wherein said criteria includes top level domain names, and said stored URL's include URL's pointing to subpages of said top level domain names, such that a user requesting a web page at a top level domain will receive a subpage thereof.

29. An apparatus as defined in claim 28 wherein said stored URL's comprise affiliate redirect pages, such that a user requesting a requested web page will receive an affiliate redirect page momentarily and then be redirected to said requested web page.

30. An apparatus as defined in claim 29 wherein said predefined criteria and said stored URL's can be modified via said second port, thereby providing the capability to easily update said list of affiliate redirect pages as affiliate relationships change.

31. A computer readable medium capable of causing a general purpose computer to implement the method of:
receiving a message, said message including a requested URL;
determining whether said requested URL matches a list of stored URL's;
if a match occurs, swapping a substitute URL in place of said requested URL to create a modified message which will result in generation of referral revenue; and
forwarding said modified message for placement onto the Internet.

32. An apparatus for directing Internet traffic so as to generate Internet traffic referral revenue, comprising:
means for receiving a request for a web page, said web page defining a requested web page;
means for determining whether said requested web page is associated with a first person who is willing to give Internet traffic referral credit;
means for modifying said request so that said entity gives said referral credit to a second person, thereby defining a modified request.

33. An apparatus as defined in claim 32 further comprising means for not modifying said request if modifying said request would result in Internet traffic referral credit being wrongly denied a third person.

34. An apparatus as defined in claim 32 further comprising means for forwarding said modified request to said first person.

35. An apparatus as defined in claim 32 wherein said determining means comprises a list of predefined domains and rules for detecting certain URL's within said predefined domains.

36. An apparatus as defined in claim 32 wherein said request for a web page includes a requested URL, and said modifying means comprises means for substituting into the request a predefined URL in place of said requested URL.

37. An apparatus as defined in claim 32 wherein said determining means comprises means for parsing a received URL and determining whether a character substring of said received URL matches at least one of a plurality of predefined character strings.

38. An apparatus as defined in claim 32 wherein said modifying means comprises substituting into the message in place of an original URL a replacement URL pointing to a first web page, the first web page having computer code for identifying the user and forwarding the user to a second web page.

39. A method of generating revenue from Internet traffic comprising the steps of:
establishing affiliate relationships with a plurality of Internet vendors;
receiving a request from an Internet user for a requested web page associated with a selected Internet vendor, said Internet user defining a first person;
instead of allowing the user to directly access the requested web page from the selected Internet vendor, redirecting the user to a second web page such that a second person is given credit by the selected Internet vendor for referring the user to the Internet vendor's website.

40. A method as defined in claim 39 wherein said second web page comprises an affiliate redirect page.

41. A method as defined in claim 39 wherein the requested web page and the second web page both reside at a world wide web site controlled by the Internet vendor, said world wide web site defining the Internet vendor's web site, and the second web page is a page which is uniquely associated with the second person by the Internet vendor such that the Internet vendor gives credit to the second person for providing traffic to the second web page.

42. A method as defined in claim 39 wherein said credit is selected from the group consisting of pay-per-referral, pay-per-purchase, and pay-per-information.

43. A method as defined in claim 39 wherein said requested web page has a URL associated therewith, said user has a computer screen, and the Internet user requested the requested web page by typing the requested web page's URL into an address bar on the user's computer screen.

44. A method as defined in claim 39 wherein said requested web page has a URL associated therewith, said user has a computer screen, and the Internet user requested the requested web page by selecting an image on the user's computer screen.

45. A method as defined in claim 39 wherein said redirecting is performed within the user's computer.

46. A method as defined in claim 39 wherein said redirecting is performed outside of the user's computer.

47. A method as defined in claim 39 wherein said redirecting is performed by an Internet Service Provider.

48. A method as defined in claim 39 wherein said redirecting is performed by a person other than by an Internet Service Provider to the user.

49. A method as defined in claim 39 wherein said redirecting is performed by a wireless hotspot operator.

50. A proxy server comprising:
a cache for holding a plurality of web pages;
an input port for receiving from a browser a request for a first web page having a first URL;
a decision section for determining whether the first URL meets a pre-defined criteria, and if so sending to the browser a second web page obtained from the Internet at a second URL different from the first URL and stored in the cache instead of the first web page.

51. The proxy server of claim 50 wherein said second web page is an affiliate redirect page.

52. The proxy server of claim 50 wherein said second web page includes at least one command that will forward the user's browser to a third web page.

53. An apparatus for directing Internet traffic so as to generate revenue comprising:
means for receiving a request from a first person defining a computer user for a requested web page associated with a web site, said received request including a first URL;
means for causing a second web page corresponding to a second URL to be sent to the user, said second URL being different from said first URL;
wherein the second web page includes means for triggering credit to be given to a second person for activity conducted by said user at said web site.

54. The apparatus in claim 53 wherein said user does not receive the requested web page.

55. An apparatus for directing Internet traffic comprising:
an input section for receiving a request from a user's computer for a first web page, the first web page having a URL defining a requested URL;
logic for testing the requested URL to determine whether it satisfies a predetermined criterion, and if so requesting a second web page having a second URL that is different from the first URL, and sending the second web page to the user instead of the requested web page;
wherein the second web page causes the user's computer to automatically request a third web page residing at a third URL, the third URL not satisfying said predetermined criterion;
such that when the user requests said first web page, the user is first sent momentarily to a second page, the user's computer is marked with an identifying file, and the user is then automatically forwarded to said third web page, without creating an infinite loop problem.

56. A method of providing search engine services comprising:
maintaining an index of pages that are on the computer network, said index including addresses at which the respective pages are located, said addresses defining unmodified addresses;
receiving a search request from a search requester;
returning to said search requester search results responsive to said search request, said search results including at least one modified address in place of at least one of said unmodified addresses, said at least one unmodified address being associated with a first entity, and said modified address being an address through which said first entity is willing to give referral credit to a second entity.

57. The method of claim 56 wherein:
said computer network is the Internet said addresses are URL's;
said first entity is an online retailer having a website; and
said modified address is selected from the group consisting of an affiliate page located on the first entity's web server and an affiliate redirect page located on a third party advertising server's web server;
whereby a provider of said search engine services receives a portion of sales made when a search engine user performs said search, clicks on a hit result to select said online retailer, and makes a purchase at the online retailer's website.
